(19) United States
(12) Patent Application Publication
(10) Pub. No.: US 2006/0229130 A1
(43) Pub. Date: Oct. 12, 2006

(54) SYSTEM FOR INCLUDING CUSTOMIZED CONTENT IN ARCADE-STYLE GAME PROGRAMMING SYSTEM

(76) Inventors: Eddie L. Bender, Bartlett, IL (US); Pierre Maloka, West Dundee, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 10/907,603

(22) Filed: Apr. 7, 2005

(51) Int. Cl. G06F 17/00; A63F 13/00

(52) U.S. Cl. 463/43

(57) ABSTRACT

Methods and systems for inserting customizable content into a computer game designed to operate in a personal computer environment that has been converted to operate in an arcade-style environment are disclosed. According to the present invention, a computer game designed to operate in a personal computer environment is operated in the personal computer environment using a computer operating system and compatible software. An arcade-style environment is created by securing the personal computer environment to prevent unwanted computer programs from running in the personal computing environment. Arcade-style environment features are added to the computer game. Communications between the computer game and the operating system are monitored and game relevant data can be communicated between the arcade-style environment and the personal computer environment. Customizable content can be inserted into the communication between the computer game and the operating system.

### BACKGROUND OF THE INVENTION

The present invention relates to computer game programming. Specifically, the present invention relates to including customized content in a computer game originally designed to operate in a personal computing environment that has been converted to operate in an arcade-style environment.

### DESCRIPTION OF THE RELATED ART

Typically a personal computer includes a central processing unit (CPU), memory devices, input devices, and output devices. Memory devices typically include random access memory (RAM) devices and read only memory (ROM) devices which can be comprised of memory chips, or other volatile memory devices, hard drives, or other non-volatile memory devices. Input devices typically include keyboards (such as alpha, numeric, or combined alphanumeric keyboards), and pointing devices (such as a mouse, touchpad, or trackball). Output devices typically include audio output devices (such as speaker systems) and video output devices (such as a monitor).

The overall operation of a computer of the type described above is controlled by the operating system. The operating system integrates the functions of the computer hardware (CPU, memory, input devices, output devices) with software loaded into the computer. For example, the operating system controls, among other things, what and how items are displayed on the monitor, how to take input from a mouse and turn that input into a pointer on the monitor as part of a graphical user interface, how to read and write data to a hard drive, and how to store information in RAM for future access.

Furthermore, the operating system integrates software to software communications for the various software programs operating in the computer. For example, a word processing software program typically displays letters or numbers on the monitor as they are entered on the keyboard. To accomplish the familiar task, the keyboard input is read by the operating system software, which communicates this piece of information to the word processing software, which receives the information and tells the operating system to display the newly typed letter or number on the monitor. The operating system software then communicates the appropriate instructions to the monitor to display the appropriate image.

The traditional arcade-style computer game machine shares many features with a personal computer. An arcade-style computer game machine encompasses arcade, vending and/or coin-operated computer game machines, as the terms are used by those skilled in the art. In arcade-style computer game machines, a user activates the machine by inserting a coin/token, inserting or swiping a credit or promotion card, card swipe, or pressing a button for free play. The machine will activate for interactive game play activity and/or video presentation/advertisement with the possibility of redemption of prizes or coupons. The user interacts with the machine for a specified time, where the specified time is controlled by software in the machine. The traditional arcade-style computer game machine has a CPU, memory, input, and output devices. However, because they are typically configured to run only one, or only a small number of games, the arcade-style computer game machine generally does not require the higher level of functionality of the personal computer operating system. In many instances, the arcade-style computer game machine hardware is developed in conjunction with the arcade-style computer game software, resulting in the arcade-style computer game software performing the function of the operating system at the same time it is performing game running functions. However, the arcade-style computer game machine also has many arcade-style machine specific features, such as accounting features to regulate game play based on inserted money or tokens, and attract mode features, which include specific displays and sounds to be played in between game play sessions.

Historically to convert a game designed to operate in a personal computer environment to a game designed to operate in an arcade-style environment required extensive rewriting of the game programming software. The rewritten game programming software will include the types of arcade-style specific features mentioned above, including arcade-style specific accounting features, display features, sound features, and control features. Rewriting the game programming software is an expensive and time consuming task.

Including advertising or other customized content into arcade style games has been known for some time. For example, many arcade style games feature messages encouraging users to avoid illegal drugs and alcohol as part of the game's attract mode. More recently, there has been interest in having customized content piped into arcade style games through a network, such as the internet. However, like the game software itself, the programming for such customized content is programmed and developed in conjunction with the arcade game machine hardware and in effect is part of the overall operating system for the arcade game machine.

There remains a need for a system that can insert advertising and other customized content into a computer game designed for a personal computing environment that has been converted to a game suitable for use in an arcade-style environment without requiring a nearly complete reprogramming of the game software. Thus, it would be advantageous to provide a system that can include customized content in a computer game designed to operate in a personal computing environment that has been converted to operate in an arcade-style environment.

### SUMMARY

In view of the deficiencies described above, it is an object of the present invention to provide a system that converts a computer game designed for a personal computing environment to a game suitable for use in an arcade-style environment without requiring a nearly complete reprogramming of the game software.

The present invention includes method and systems for inserting customizable content into a computer game originally designed for a personal computing environment that has been converted to a game suitable for use in an arcade-style environment.

According to the present invention, a computer game designed to operate in a personal computer environment is operated in the personal computer environment using a computer operating system and compatible software. An arcade-style environment is created by securing the personal computer environment to prevent unwanted computer programs from running in the personal computing environment; this can be accomplished, in part, by replacing the default operating system interface with an arcade-style operations interface.

Arcade-style environment features are added to the computer game. Arcade-style environment features include arcade-style specific accounting features, arcade-style specific sounds, arcade-style specific displays, and arcade-style specific controls.

Communications between the computer game and the operating system are monitored. Game relevant data can be communicated between the arcade-style environment and the personal computer environment. Typically, these communications are accomplished using messaging software.

The customized content can include advertising or other content that the arcade operator wishes to have displayed as part of the game experience. The customized content can be stored locally on the computer running the arcade-style game machine or can be stored on computer network. This network can be either a closed localized network, or a public network, such as the internet.

Other features and advantages of the invention will be apparent from the following detailed description taken in conjunction with the following figures, wherein like reference numerals represent like features.

### BRIEF DESCRIPTION OF THE FIGURES

FIG. 1 shows a representation of the present invention in block diagram form.

FIG. 2 shows the operation of the present invention in block diagram form.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

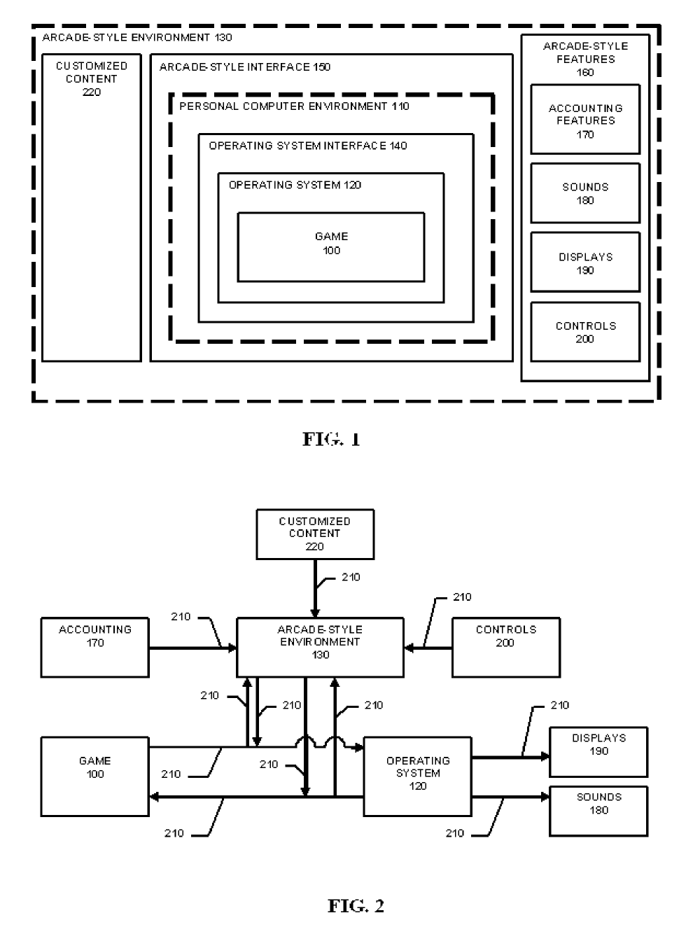

The present invention is a system for operating a computer game or other computer program that was originally designed and intended to run in a personal computer environment in an arcade-style type environment. FIG. 1 shows a representation of an arcade-style computing environment according to the present invention in block diagram form. In the present invention the computer game 100 is operated in the environment it was intended to operate in, namely a personal computing environment 110 using a conventional operating system 120, and an arcade-style environment 130 is created around the personal computing environment 110. Examples of conventional operating systems include, but are not limited to, MICROSOFT® WINDOWS® based operating systems or LINUX® based operating systems.

The arcade-style environment 130 is created by securing the personal computing environment 110, as much as present technology allows a computer to be secured. Securing the personal computer environment restricts access to the computer and prevents unwanted programs or processes from running in the personal computing environment 110. In part, the arcade-style environment 130 is created by replacing the default operating system interface 140 with an arcade-style operations interface 150. For example, for a computer running a MICROSOFT® WINDOWS® based operating system, the WINDOWS® desktop is replaced by an arcade-style interface 150 that limits access to desired computer programs, such as the computer game 100 loaded into the machine and or other arcade-style operation processes.

Arcade-style environment features 160 are added to the computer game 100 through computer programs that act as an overlay to the computer game 100 and interface between the computer game 100 and the operating system 120. The arcade-style environment 130 features can include accounting features 170, arcade-style specific sounds 180, arcade-style specific displays 190, and arcade-style specific controls 200.

To know when and what arcade-style features 160 to add at any particular moment, the present invention includes computer programs to monitor communications between the computer game 100 the said operating system 120 and communicate game relevant data between the arcade-style environment 130 the said personal computer environment 110. FIG. 2 shows the operation of the present invention in block diagram form. For example, the typical computer game 110 draws or redraws or refreshes the appearance of the display many times per second. In order to accomplish this, the computer game 100 communicates with the operating system via messaging software 210. In the example case, the messages would include requests and data from the computer game 100 to the operating system 120 to redraw the display. The present invention can monitor these messages and, where appropriate, add, remove, or modify the data to make the computer game 100 play appropriate for the arcade-style environment 130. In the display redraw example case, the present invention can add data to display redraw message to add in display information for remaining credits. The same principle applies for any of the arcade-style specific accounting features 170, arcade-style specific sounds 180, arcade-style specific displays 190, and arcade-style specific controls 200.

As part of adding arcade-style features 160 to the computer game 100, game features specific to game play in the personal computing environment 110 can be turned off or have access to these features restricted so that the arcade-style operator retains controls of these features. For example, in the personal computing environment 110, the game may have user selectable features for screen resolution, difficulty level, network play, or redefineable controls, among other things. As will be discussed below, in the arcade-style environment 130 these features are controllable, if at all, by the arcade-style operator and not the game player.

Arcade-style accounting features 170 include the computer programs and related hardware needed for coin operation and arcade-style operator control of the computer game. These features can include credits per play, coins per credit, coins received in each coin slot, credits per continue, free play mode, one and two player game modes, one and two player continue modes, first extra play score, additional extra play score, first extra play time, additional extra play time, first prize ticket score, additional prize ticket score, first prize ticket time, additional prize ticket time, start time, continue time, and difficulty levels. Other accounting features can include historical and or statistical information regarding game play, such as longest game time, average game time, average continue time, highest level played, average level played per game. Many of the accounting features 170 may be adjustable by an arcade-style operator to achieve a desired level of profits and gaming enjoyment. Other accounting features 170 known to those skilled in the art may also be included.

Arcade-style specific sounds 180 include sounds that generally would not be programmed into a computer game 100 designed for use in a personal computing environment 110, but are typically used in the arcade-style environment 130. For example, it is common practice in the arcade-style game industry to play a specific sound each time a coin is entered into a coin slot. Such a sound would not be applicable for a game designed for play in a personal computing environment 110. Arcade-style specific sounds 180 can include game music, game music volume, game sound effects, game sound effects volume, attract mode music, attract mode volume, attract mode sound effects, and attract mode sound effects volume. As with the accounting features 170, many of the arcade-style specific sounds 180 may be adjustable by an arcade-style operator. Other arcade-style specific sounds 180 known to those skilled in the art may also be included.

Arcade-style specific displays 190 include displays and elements of displays that generally would not be programmed into a computer game 100 designed for use in a personal computing environment 110, but are typically used an arcade-style environment 130. For example, it is common practice in the arcade-style game industry to display the number of “lives” the game player has left. In many computer games 100 designed for play in a personal computing environment 110, such a display is not required. Arcade-style specific displays 190 can include remaining lives, remaining time, continue time remaining, credits remaining, attract mode displays and high score tables. As with the accounting features 170, many of the arcade-style specific displays 190 may be adjustable by an arcade-style operator. Other arcade-style specific displays 190 known to those skilled in the art may also be included.

Arcade-style specific controls 200 include controls that generally would not be programmed into a computer game 100 designed for use in a personal computing environment 110, but are typically used an arcade-style environment 130. For example, it is common practice for computer game 100 play in computer games designed for use in a personal computing environment 110 to be controlled by a combination of keyboard and mouse inputs. However, in the arcade-style environment 130 game play is typically controlled by a limited number of buttons, joysticks and trackballs. Many times there is not a convenient one-to-one correlation between the controls for computer game 100 play in the personal computing environment 110 and computer game 100 play in the arcade-style environment 130. For example, in the personal computing environment 110, the computer game 100 may use the letters “A”, “S”, “W”, and “X” inputted on a keyboard to move a character to the left, right, forward, and backward, respectively in the game, however, in the arcade-style environment 130 it may be more appropriate to control these movements with a single joystick. Accordingly, in various embodiments it may be necessary to map arcade-style specific control 200 outputs to inputs compatible with the computer game 100 when the computer game 100 is operating in a personal computer environment 130. As with the other features, many of the arcade-style specific controls 200 may be adjustable by an arcade-style operator. Other arcade-style specific controls 200 known to those skilled in the art may also be included.

As stated above, the present invention can monitor the messages, sent via the messaging software 210, between the computer game 100 and the operating system 120 and, where appropriate, add, remove, or modify the data to make the computer game 100 play appropriate for the arcade-style environment 130. Part of the data added into the messages can include customized content 220. The customized content can include advertising or other content that the arcade operator wishes to have displayed as part of the game experience.

The customized content 220 can be stored locally on the computer running the arcade-style game machine. Preferably, the customized content 220 originates from, or is stored on, a computer network. This network can be either a closed localized network, or a public network, such as the internet. This allows the arcade operator to have the customized content 220 available to multiple arcade-style game machines at the same time. Additionally, this allows the arcade operator to modify the customized content at a single source for all the arcade-style game machines on the network.

The inclusion of customized content 220 into the arcade-style game opens an alternative revenue stream for the arcade operator. For example, the arcade operator can contract with content providers, wherein the arcade operator allows the content provider to display their content on the operator's arcade-style game machines in exchange for payment from the content provider to the arcade operator.

While specific embodiments have been illustrated and described, numerous modifications come to mind without significantly departing from the spirit of the invention and the scope of protection is limited by the scope of the accompanying claims.

What is claimed is:

1. A method for including customizable content in a computer game designed to operate in a personal computer environment operating in an arcade-style environment comprising:
operating a computer game designed to operate in a personal computer environment in a personal computer environment using a computer operating system and compatible software,
creating an arcade-style environment by securing said personal computer environment to prevent unwanted computer programs from running in said personal computing environment,
monitoring communications between said computer game and said operating system,
communicating game relevant data between said arcade-style environment and said personal computer environment, and
inserting customizable content into said communications between said arcade-style environment and said personal computer environment.

2. The method for operating a computer game designed to operate in a personal computer environment in an arcade-style environment according to claim 1, wherein said computer operating system is a MICROSOFT WINDOWS based operating system.

3. The method for operating a computer game designed to operate in a personal computer environment in an arcade-style environment according to claim 1, wherein securing said personal computer environment comprises replacing a default operating system interface with an arcade-style operations interface.

4. The method for operating a computer game designed to operate in a personal computer environment in an arcade-style environment according to claim 3, wherein said default operating system interface is a WINDOWS desktop user interface.

5. The method for operating a computer game designed to operate in a personal computer environment in an arcade-style environment according to claim 1, wherein inserting customizable content into said communications between said arcade-style environment and said personal computer environment comprises inserting customizable content over a computer network.

6. The method for operating a computer game designed to operate in a personal computer environment in an arcade-style environment according to claim 5, wherein said network is a local network.

7. The method for operating a computer game designed to operate in a personal computer environment in an arcade-style environment according to claim 5, wherein said network is a public network.

8. The method for operating a computer game designed to operate in a personal computer environment in an arcade-style environment according to claim 7, wherein said public network is the internet.

9. The method for operating a computer game designed to operate in a personal computer environment in an arcade-style environment according to claim 1, wherein said communicating game relevant data between said arcade-style environment and said personal computer environment comprises sending and receiving data between said arcade-style environment and said personal computer environment via window messaging software.

10. A system for converting a computer game designed to operate in a personal computer environment to operate in an arcade-style environment comprising:
a computer having memory, a processor, means for receiving input, means for displaying information, and a computer operating system,
software enabled means for running a computer game using said operating system and compatible software,
software enabled means for creating an arcade-style environment by securing said personal computer environment to prevent unwanted computer programs from running in said personal computing environment,
software enabled means for monitoring communications between said computer game and said operating system,
software enabled means for communicating game relevant data between said arcade-style environment and said personal computer environment, and
software enabled means for inserting customizable content into said communications between said arcade-style environment and said personal computer environment.

11. The system for converting a computer game designed to operate in a personal computer environment in an arcade-style environment according to claim 10, wherein said computer operating system is a Microsoft Windows based operating system.

12. The system for converting a computer game designed to operate in a personal computer environment in an arcade-style environment according to claim 10, wherein securing said personal computer environment comprises software enabled means for replacing a default operating system interface with an arcade-style operations interface.

13. The system for converting a computer game designed to operate in a personal computer environment in an arcade-style environment according to claim 12, wherein said default operating system interface is a WINDOWS desktop user interface.

14. The system for converting a computer game designed to operate in a personal computer environment in an arcade-style environment according to claim 10, wherein said customizable content is stored locally on said computer.

15. The system for converting a computer game designed to operate in a personal computer environment in an arcade-style environment according to claim 10, wherein said computer is connected to a network and said customizable content is stored on said network.

16. The system for converting a computer game designed to operate in a personal computer environment in an arcade-style environment according to claim 15, wherein said network is a local network.

17. The system for converting a computer game designed to operate in a personal computer environment in an arcade-style environment according to claim 15, wherein said network is a public network.

18. The system for converting a computer game designed to operate in a personal computer environment in an arcade-style environment according to claim 17, wherein said public network is the internet.

19. The system for converting a computer game designed to operate in a personal computer environment in an arcade-style environment according to claim 10, wherein said software enabled means for communicating game relevant data between said arcade-style environment and said personal computer environment comprises software enabled means for sending and receiving data between said arcade-style environment and said personal computer environment via window messaging software.
